(19) United States
(12) Patent Application Publication
(10) Pub. No.: US 2016/0092854 A1
(43) Pub. Date: Mar. 31, 2016

(54) SYSTEM AND METHOD FOR USING BOOK RECOGNITION TO FACILITATE A USER'S ACQUISITION OF E-BOOKS

(71) Applicant: Kobo Inc., Toronto (CA)

(72) Inventors: James Wu, Newmarket (CA); Dae Hyuk Yoon, Toronto (CA); Sneha Patel, Mississauga (CA); Sameer Hasan, Mississauga (CA)

(21) Appl. No.: 14/498,426

(22) Filed: Sep. 26, 2014

(51) Int. Cl. G06Q 20/12; G06K 9/32; G06K 9/62; G06Q 30/06; H04L 29/08

(52) U.S. Cl. CPC G06Q 20/123; G06Q 30/0633; G06Q 30/0635; H04L 67/1095; G06K 9/6202; G06K 9/3258

(57) ABSTRACT

An image of a physical book environment is obtained, and the image is associated with a user. The image is processed to detect one or more books in the physical book environment. A title is determined of at least a first book in the physical book environment. One or more operations are then performed to facilitate acquisition of an e-book version of the determined title for the user.

### TECHNICAL FIELD

Examples described herein relate to a system and method for using book recognition to facilitate a user's acquisition of e-books.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for using book recognition to facilitate a user's acquisition of e-books, according to an embodiment.

FIG. 2 illustrates an example of an e-reading device for use with one or more embodiments described herein.

FIG. 3 illustrates an example device system for enabling book recognition and use, according to an embodiment.

FIG. 4 illustrates a book recognition system for use with one or more embodiments described herein.

FIG. 5 illustrates an example method for using book recognition to facilitate a user's acquisition of e-books.

### DETAILED DESCRIPTION

Examples described herein enable a user of an e-reading device to capture an image of a physical book environment in which one or more physical or real-world books are placed. The physical book environment can correspond to a physical bookshelf, table setting, or other environment in which books are placed. The image of the physical book environment can be used to identify e-books that the user wants to purchase or obtain, or is likely to want to obtain or purchase at a later time. More specifically, the image of the physical book environment is analyzed to determine the book titles that are depicted in the image. In one implementation, an e-book version for each of the detected titles is transferred to an account of the user. In a variation, an e-book version for each of the detected titles is made available for prompt purchase and download to the user.

According to an embodiment, an image of a physical book environment is obtained, and the image is associated with a user. The image is processed to detect one or more books in the physical book environment. A title is determined of at least a first book in the physical book environment. One or more operations are then performed to facilitate acquisition of an e-book version of the determined title for the user.

By way of an example, embodiments described herein enable a user to jumpstart their e-book collection by identifying a bookshelf (e.g., at a bookstore or library) on which books of interest are provided. The user can operate an e-reading device to capture an image of the bookshelf where books of interest reside. A programmatic process can then be initiated then with the server that automates or otherwise facilitates the ability of the user to purchase or otherwise obtained e-book versions of book titles appearing on the shelf.

The term “physical book environment” means a physical or real-world environment in which books are placed. An example of a physical book environment is a bookshelf, on which books (including magazines and journals) can be placed in a vertical, horizontal or tilted orientation, with their spines or book jackets facing outward.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular.

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Overview

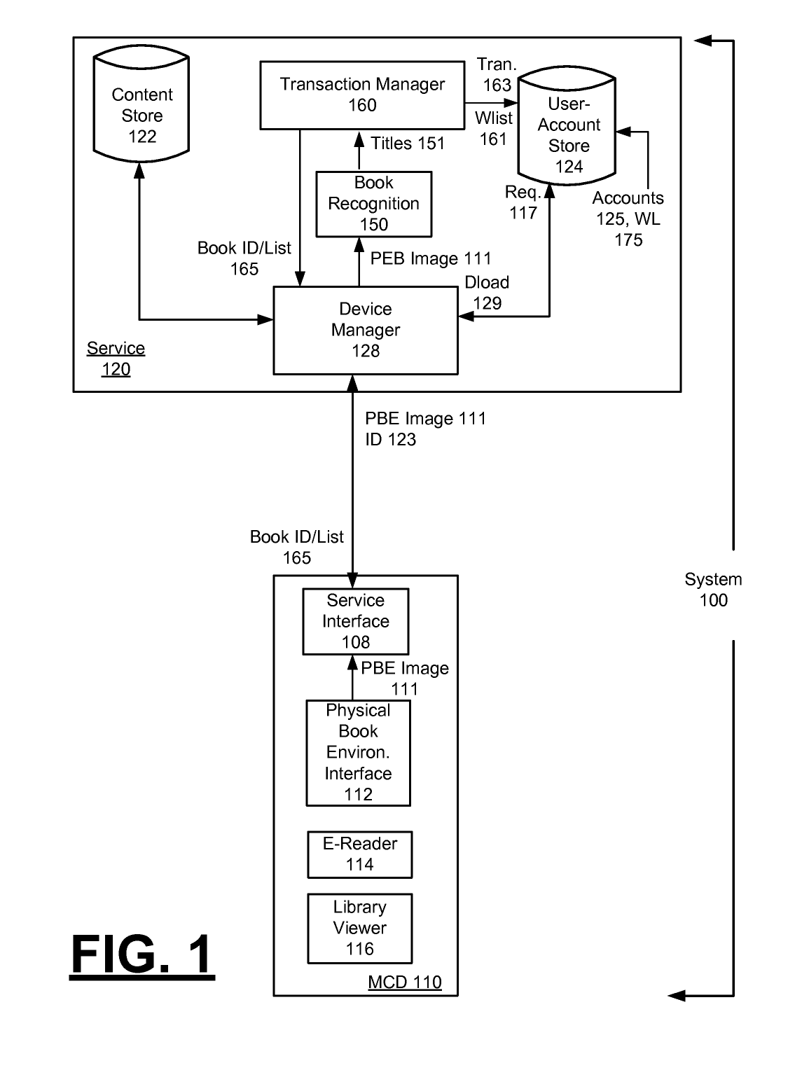

FIG. 1 illustrates a system for using book recognition to facilitate a user's acquisition of e-books, according to an embodiment. In an example of FIG. 1, system 100 includes an e-reading device 110 and a network service 120. The network service 120 may include multiple servers and other computing resources that provide various services in connection with one or more applications that are installed on the e-reading device 110. By way of example, in one implementation, the network service 120 can provide e-book services which communicate with corresponding e-book functionality provided on the e-reading device 110. The e-book services can enable e-books to be downloaded or archived from e-reading device 110. The network service 120 can also provide other forms of content for download or streaming, such as videos or music. In this way, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can correspond to a mobile computing device (e.g., tablet) that runs an e-reading application to link the device to the network service 120 in order to enable e-books provided through the service to be viewed and consumed. Still further, by way of example, the e-reading device 110 can be equipped with hardware and software to optimize certain application activities, such as rendering of electronic content (e.g., e-books). For example, the e-reading device 110 can have a tablet like form factor, although variations are possible. In some cases, the e-reading device 110 can also have an E-ink display.

In additional detail, the network service 120 can include a device manager 128, a book recognition component 150, a transaction manager 160, a content store 122 and a user account store 124. The user account store 124 can associate the e-reading device 110 with a user and with an account 125. The account 125 can also be associated with one or more application resources (e.g., content item such as an e-books), which can be stored in the content store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

The device manager 128 can provide an interface to the e-reading device 110. In one implementation, the content store 122 can include an online store which can be accessed by the e-reading device 110 through the device manager 128. In one implementation, the user can purchase or otherwise obtain an e-book and associate the e-book with the account 125 through interaction handled by the device manager 128. The e-reading device 110 can signal a request 117 and then receive a download 129 of a copy of a particular e-book. As another example, the request 117 can also specify archived copy of an existing e-book.

The e-reading device 110 can include a service interface 108, a physical book environment interface 112, an e-reading component 114 and a library view component 116. The e-reading device 110 can execute the service interface 108 to receive resources and data from the network service 120. The service interface 108 can signal the network service 120 an identifier 123 for the user and/or user account. The service interface 108 can interface with the network service 120 to receive resources such as applications and content items (e.g., e-books, music files, etc.) from the network service. Optionally, the e-reading device 110 can communicate with multiple services in order to receive resources.

The e-reading device 110 can execute the e-reading component 114 to enable e-reading activities. In particular, the e-reading component 114 can render paginated content from e-books (e.g., electronically formatted literary works, including periodicals).

The library view component 116 can include a user interface that provides a presentation of the content items (e.g., e-books, including magazines and periodicals) in a defined library. The library can include the user's entire collection of e-books, as well as e-books that are being promoted or otherwise displayed through metadata content on the user device. For example, a library can include e-books in a user collection and/or e-books that network service 120 is promoting and/or making available for purchase or download. The presentation of the content items can be based on metadata content associated with the individual content items. For example, in the case of e-books, the metadata content used to display representations of the e-books in the user library can include images provided by the publisher (e.g., icons or graphic objects) which represent or appear as a book cover or jacket. Likewise, in the case of music or movies, representations of the content items in the user's library can be based on icons or graphic objects that represent album art (music) or box cover art (movies).

The library view component 116 can generate presentation of e-books or other content items of the user's library using a variety of paradigms. For e-books in particular, the library view component 116 can display the metadata content of the e-books (e.g., icons representing book or magazine covers) in the form of lists, or on a virtual bookshelf that is personalized for the user library (e.g., a book shelf displaying portions of icons representing book covers, magazine covers and/or comic book covers which are in the user library).

According to an embodiment, the physical book environment interface 112 includes an interface to a camera of the e-reading device 110. The physical book environment interface 112 can also include programming for enabling the user to interact with displayed content provided through a photo application or camera viewer. The physical book environment interface 112 enables the user to operate the camera in order to capture an image of a bookshelf, tabletop or other environment in which one or more physical, real-world books are provided. In operation, the physical book environment interface 112 can be used to capture a physical book environment image 111, depicting a bookshelf or other physical book environment on which books are provided. The physical book environment interface 112 can include functionality to enhance the image for purpose of book recognition. Among other features, the user can crop or center the image that is to be captured so that the image is primarily of the environment in which books are actually located. Other settings or features can be implemented to reduce glare or improve shading, so as to facilitate subsequent character recognition. In one variation, the physical book environment interface 112 can also enable the user to enter tags or other metadata information in association with specific items depicted in image, to facilitate a subsequent book recognition processes.

In a variation, the physical book environment interface 112 can interface with stored images, which the device can receive by way of, for example, a messaging program or browser download. The physical book environment interface 112 can also include implementations in which stored images can be tagged or manipulated by the user to facilitate a subsequent book recognition processes.

In one implementation, the physical book environment interface 112 communicates the image 111 to the service interface 108. The service interface 108 communicates the physical book environment image 111 to the network service 120, along with identification information that correlates the communication(s) from the e-reading device 110 to a specific account 125. The device manager 128 of the network service can receive the physical book environment image 111, along with the identifier associated with image.

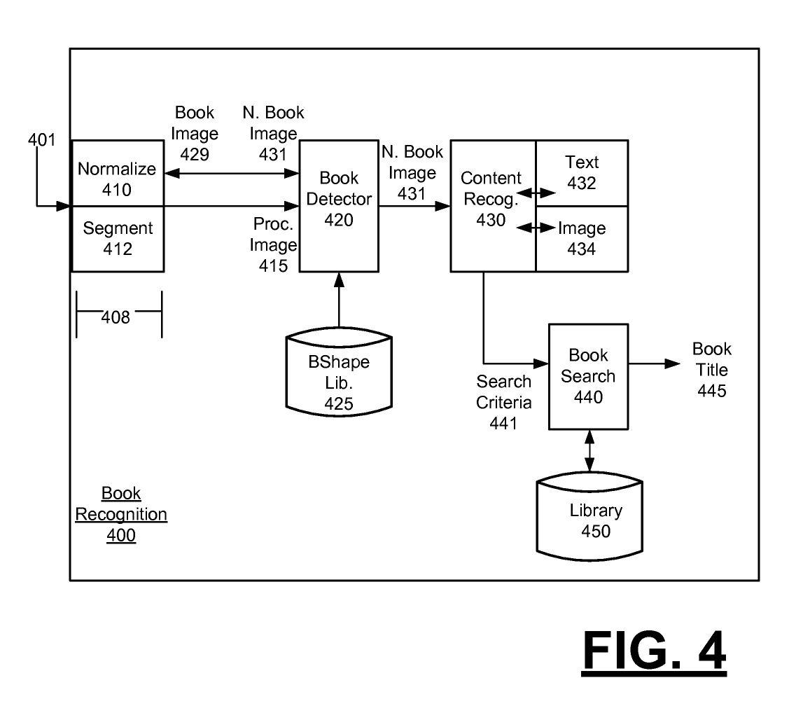

The device manager 128 can forward the physical book environment image 111 to a book recognition component 150. The book recognition component 150 includes processes to (i) detect individual books in the image 111, and (ii) determine titles for the detected books based on text content and/or image content appearing on the jacket or spine of the detected book. In this way, the book recognition component 150 can detect and recognize multiple physical books in a given setting. Further, as described with other examples, the books recognition component 150 can detect and recognize books that have different orientations (e.g., vertical, tilted, horizontal, etc.) in the depicted environment. An example of book recognition component 150 is provided with FIG. 4.

The book recognition component 150 can communicate the titles 151 that are recognized from the physical book environment image 111 to the transaction manager 160. The transaction manager 160 can use the submitted book titles 151 as input in performing operations to automate or otherwise facilitate completion of the transaction. In one implementation, transaction manager 160 receives the submitted book titles 151, then accesses the account 125 of the user and automatically executes a transaction 163 for the book titles 151 identified in the input. The execution of the transaction 163 can result in (i) funds from the user account being debited, and (ii) e-book versions of the identified titles 151 being linked to the user account 125. Additionally, execution of the transaction 163 can result in the e-book versions of the identified titles being automatically downloaded to the e-reading device 110. The user can then download the e-book versions of the identified titles 151. In such an implementation, the submission of the physical book environment image 111 can be assumed to convey an intent of the user to purchase the book titles in the image. Such an assumption can be made by default or by a user specified setting on the e-reading device 110.

In a variation, the transaction manager 160 generates a list that includes book identifiers (“book ID/list 165”). The book ID/list 165 can be communicated to the e-reading device 110 via the device manager 128. The user can then confirm his or her desire to purchase the e-book versions of the displayed titles in the book ID/list 165. The user can also select titles from the book ID/list 165 rather than purchased the entire list. Still further, the user can specify different purchasing or acquisition options for individual titles listed in the book ID/list 165. For example, a user can select from options that include viewing a preview of an e-book version, adding the e-book version to a user's wish list, searching for or acquiring “used” e-book version of an identified title, purchasing the e-book versions of the book titles immediately, purchasing e-book versions of the book titles at a later date, and/or gifting an e-book version of the identified title to another person.

Still further, the transaction manager 160 can use one or more of the identified titles 151 to signal an addition 161 (or multiple additions 161) to a wish list 175 associated with the user's account 125. The wish list 175 can correspond to titles which the user would like to purchase or otherwise download over time.

While an example of FIG. 1 depicts components such as book recognition component 150 and/or transaction manager 160 residing with network service 120, alternative implementations can provide for some or all of those components to reside with the e-reading device 110. For example, the e-reading device 110 can implement the book recognition component 150 and/or the transaction manager 160, and subsequently signal the network service 120 identifiers for those recommended content items that the user wishes to obtain or associate with the user account 125. Still further, the e-reading device 110 can include some but not all of the processes or components of the book recognition component 150 and/or transaction manager 160. For example, some processes of book recognition component 150 can be implemented on the e-reading device 110, while the network service 120 performs other processes to complete the recognition and determination of titles 151.

Hardware Description

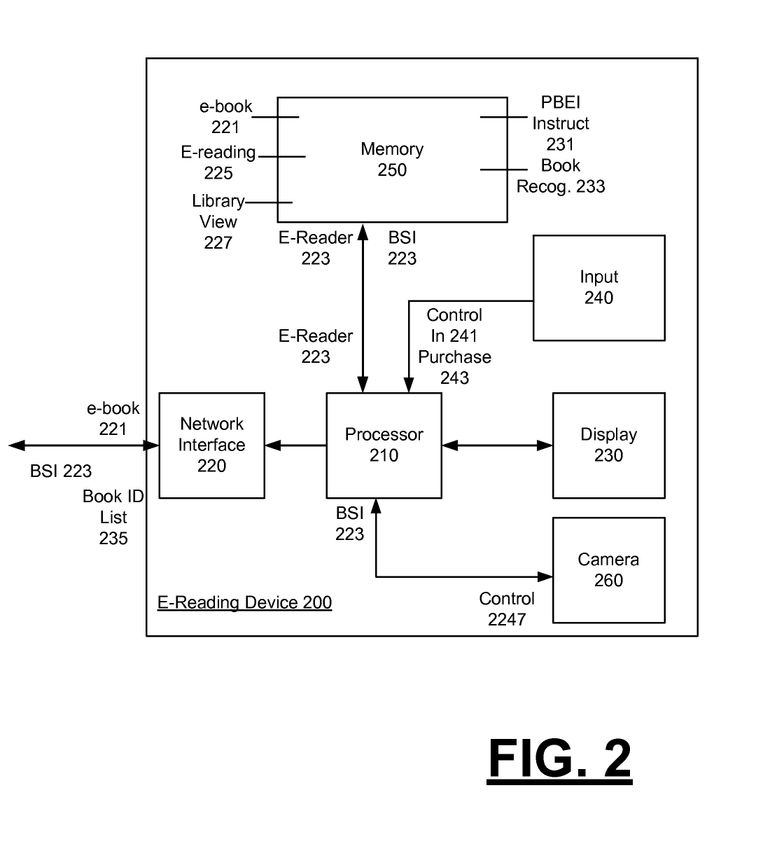

FIG. 2 illustrates an example of an e-reading device for use with one or more embodiments described herein. In an example of FIG. 2, an e-reading device 200 can correspond to, for example, a mobile computing device (e.g., smartphone, tablet) that can be implemented in accordance with an example of FIG. 1.

With reference to FIG. 2, e-reading device 200 includes a processor 210, a network interface 220, a display 230, one or more input mechanisms 240, a memory 250, and a camera 260. The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books 221, configuration files, account information), as well as to provide information (e.g., user account information, service requests etc.). For example, e-reading device 200 can receive application resources, such as media files (e.g., e-books 221) that the user elects to purchase or otherwise download from the network service 120. The application resources that are downloaded onto the e-reading device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230. Additionally, as described below and with other examples, the processor 210 can receive input from the camera 260 (e.g., physical book environment image 223).

In one aspect, memory 250 stores instructions 225 (“e-reading instructions 225”) for operating an e-reading application (e.g., see e-reading component 114 in FIG. 1). The memory 250 can also store library view instructions 227 for providing a library view component (e.g., see library view component 116 in FIG. 1). The processor 210 can execute the library view instructions 227 to display various forms of lists representing the collection of e-books 221 in the user collection. Additionally, the memory 250 can include instructions 231 for implementing the physical book environment interface 112 (see FIG. 1) (“PBEI instructions 231”). The processor 210 can execute the PBEI instructions 231 to control the e-reading device 200 in capturing an image of the physical book environment, and further to enhance or communicate the image to the network service 120.

Still further, in some variations, the memory 250 stores instructions for implementing some or all of the book recognition component 150 (see FIG. 1) (“book recognition instructions 233”). The processor 210 can implement book recognition instructions 233 to perform some or all of the steps necessary to recognize the titles of books depicted in physical book environment images.

In one implementation, the processor 210 can execute the PBE instructions 231 to enable the camera 260 to capture and provide the PBE image 223. The input device 240 can be used to specify control input 241, which is used by the processor to control 247 the operation of the camera 260 in capturing the image. The processor 210 communicates the PBE image 223 to the network service 120 in order to acquire or otherwise perform acquisition actions for the identified titles. In response to communicating the PBE image 223, the e-reading device can receive a book ID/list 235 which identifies the titles of the PBE image, from which selection or other purchasing action (“purchase input 243”) can be made.

Device System

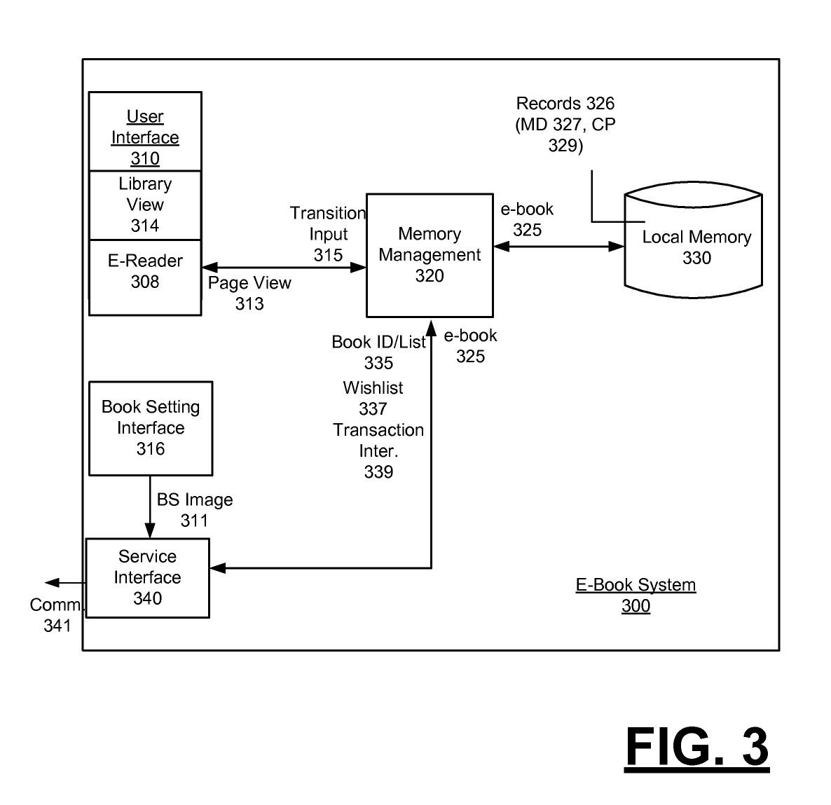

FIG. 3 illustrates an example device system for enabling book recognition and use, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reading device 110 (see FIG. 1). In some embodiments, the system 300 can be implemented as an application that runs on an e-reading device, such as shown with examples of FIG. 1 or FIG. 2. In variations, the system 300 can be implemented as part of the operating system for the e-reading device.

In an example of FIG. 3, system 300 includes a user interface 310, a memory management module 320, a local memory 330, a service interface 340 and a physical book environment interface 316. Some or all of the programmatic components shown with the computing system 300 can be provided in part as operating system-level components. Alternatively, the programmatic components shown with the computing system 300 can be provided as part of an application that runs on, for example, the e-reading device 110 (see FIG. 1). For example, the user can download an application onto the device that is operated as the e-reading device 110, in order to obtain functionality such as described with an example of FIG. 3, as well as to communicate with the network service 120. Alternatively, an application can be embedded or otherwise preinstalled with other programmatic elements for providing functionality such as described with system 300.

The service interface 340 includes application logic which enables the e-reading device 110 to use, for example, a wireless Internet connection, to connect to the network service 120 (see FIG. 1). In connecting with the service, the service interface 340 can transmit data that enables the network service 120 to identify the e-reading device 110 on which system 300 is implemented, so that the network service 120 can determine the account that is associated with the particular e-reading device. The service interface 340 can be used to retrieve e-books 325 from the network service 120. For example, in identifying the e-reading device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Individual e-books 325 also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reading device of system 300, the network service 120 can identify what e-books belong to the account associated with the particular device. The e-books that are transmitted to the e-reading device of system 300 can include, for example, those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reading device 110 to automatically receive their previously purchased e-book. As another example, network service 120 can be configured to push e-books to the e-reading device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reading device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of the content 329 for individual e-books for purpose of rendering e-books via the user interface 310. Additionally, the management module 320 can retrieve metadata 327 to render metadata content (e.g., representations of e-books or lists of e-books) with the user interface 310.

In an example of FIG. 3, the user interface 310 of e-book system 300 includes an e-reading component 308 and a library view component 314. The e-reading component 308 can include functionality to (i) render page views 313 from a particular e-book, and (ii) detect transition inputs 315. The page views 313 can include the content portion 329 of the e-book being read (e.g., opened or rendered). For example, the e-reading component 308 can display a page view 313 from an e-book corresponding to a novel or periodical, and the page view may include text and/or image content. The transition input 315 can correspond to, for example, a page turn, a chapter turn, or a clustered page turn.

The library view component 314 can display objects and metadata that represent individual e-books and content items of the user library. In one implementation, the library view component 314 can display metadata content based on the metadata portion 327 of individual e-books that are in the user library. The e-books that are in the user library can correspond to e-books stored with local memory 330, as well as archived e-books that are provided remotely (e.g., provided on network service 120).

More specifically, in some implementations, the memory management module 320 can be triggered into archiving e-books. In archiving an e-book, the content portion 329 of the e-book can be removed from the local memory 330, while the metadata portion 327 of the record 326 remains stored in the local memory 330. The trigger for archiving e-books can be based on the user input, or generated programmatically in response to events such as memory management processes (e.g., process to archive e-books that have been read; process to detect when free memory is below threshold, etc.). The library view component 314 can display the representation of the archived e-books using the metadata content 327.

In one implementation, the physical book environment interface 316 can be used to capture or otherwise select the physical book environment image (“PBE image 311”). As described with other examples, physical book environment interface 316 can enable software-based control of a camera to facilitate the user capturing an image of a book environment, such as a bookshelf or tabletop. In some variations, the physical book environment interface 316 includes functionality to enhance the captured image based on known characteristics of captured images for bookshelves or tabletops. For example, the physical book environment interface 316 can implement functionality to reduce glare or enhance focus to capture text appearing on the jacket cover or spine of the physical book. Additionally, the physical book environment interface 316 can enable the user to focus the captured image on a specific region of the scene where the books of interest are present. For example, the user can provide input to maximize the relative size of a particular bookshelf in the image, as compared to other bookshelves that could also appear in the image. The physical book environment interface 316 can provide the PBE image 311 for communication to network service 120 via the service interface 340.

A communication 341 specifying the PBE image 311 can be communicated to the network service 120. In response, one implementation provides for the network service 120 to make available e-book versions of the book titles identified in PBE image 311. As a variation, the network service 120 can signal the memory management module 320 information for display regarding book titles that are recognized from the PBE image 311. The information can include (i) a book/ID list 335, which enables the user to confirm or select specific entries for purchase or acquisition, (ii) a wish list update 337 indicating one or more titles in recognized from the image have been added to the user's wish list, and/or (iii) a transaction interface 339 to enable the user to specify input for performing any one of multiple kinds of transactions, including searching or acquiring “used” titles and and/or gifting one or more of the recognized titles.

Book Recognition Component

FIG. 4 illustrates a book recognition component for use with one or more embodiments described herein. A book recognition component 400 such as shown by FIG. 4 can be implemented as, for example, the book recognition component 150 of system 100, shown with FIG. 1. In such examples, the book recognition component 400 can be implemented as part of a network service that communicates with e-reading devices of users who have accounts with the network service. While some examples provide for the book recognition component 400 to be implemented as part of the network service 120, other variations provide for implementing some or all of the processes that are included in the book recognition component 400 on an e-reading device (e.g., e-reading device 110 running the e-reading component 114). For example, the e-reading device 200 can execute the book recognition instructions 233 in order to implement some or all of the functionality described with an example of FIG. 4.

With reference to FIG. 4, book recognition component 400 includes one or more preprocessing components 408, a book detector 420, a content recognition component 430, and a book search component 440. The preprocessing 408 include one or more normalization processes 410 and/or segmentization 412. In operation, preprocessing components 408 receive a physical book environment image 401. When book recognition component 400 is implemented on a network service 120, the physical book environment image 401 can be received over a network from a coupled e-reading device. Normalization 410 can, for example, (i) align the physical book environment image 401, and (ii) perform pixel-based operations to normalize lighting effects (e.g., glare or shade). Segmentization 412 can identify the foreground portion of the image, which can correspond to the physical books (e.g., the spines or jackets), and optionally portions of the shelf or environment.

The processed image 415 is communicated to a book detector 420, which operates to identify the presence of book shapes in the foreground of the image. The book detector 420 can utilize a library of book shape templates 425 in order to identify whether and where books are located in the image 415. The book shape templates 425 can include spine shapes for books of different sizes, such as hard back books, paperback novels, thick magazines, journals, etc. The book shape templates 425 can also include templates for the spines of various different types of books in alternative orientations. Such alternative orientations can include a vertical orientation (e.g., book is positioned upright between other books on a bookshelf), a horizontal orientation (e.g., book is laid flat on a bookshelf), a right tilt orientation (e.g., book is vertical, with top of book leaning rightward against another book or wall, at an angle of 45°, or between 30 to 60°) or a left tilt orientation (e.g., opposite of right tilt orientation). Still further, the book shape templates 425 can include shapes for the front or back cover of books of the different types (e.g., hardback, paperback, journal, magazine, etc.). The front or back cover templates can be used to detect when physical books are displayed frontally in the environment, such as in the case when a picture book is positioned on a bookshelf with the entire front cover facing outward, rather than the spine. In this way, multiple books in varying orientations (e.g., vertical spine outward, front cover facing etc.) can be detected from an image of a physical environment.

The book detector 420 can obtain a book image 429 from the processed image 415. The book image 429 includes (i) an image representation (based on the physical book environment image 401) of either a physical book spine, front cover, back cover or hybrid orientation, and (ii) content depicted on the spine and/or cover of the depicted books and image. The content depicted on the spine and/or cover of a given book depicted in the book image 429 can include text content, photographic image content or imagery (e.g., illustrations), or coded image content.

When the book image 429 is determined for a given book, it can be communicated to the content recognition component 430. However, examples recognize that the book image 429 can have alternative orientations (e.g., vertical, tilted etc.) based on the orientation of the book and also on the orientation of the content relative to the depicted book jacket or spine. In one implementation, the book detector 420 uses the one or more normalization processes 410 to normalize the book image 429 so that the appearance of text characters are normalized in a common orientation (e.g., left to right). For example, normalization process 410 can operate to make text appearing in the spine of a book horizontal, when the characters are originally vertical or tilted as a result of the vertical orientation of the book.

The normalize book image 431 is communicated to the content recognition component 430. The content recognition component 430 can include text recognition logic 432 and/or image recognition logic 434. The text recognition logic 432 scans the book image 431 for the appearance of alphanumeric characters, and then generates text data representing the detected characters. The image recognition logic 434 can detect a book cover image provided on the spine, front or back of a given book. The image recognition logic 434 can generate a signature representation of a detected image. In this way, the content recognition component 430 generates a search criteria 441 that can include recognized text characters and/or an image signature.

The book search component 440 utilizes the search criteria 441 to search a library 450 of book identifiers. The library of book identifiers 450 can enable searching by book title. In some variations, the library of book identifies 450 can also enable searching by author and/or book cover image.

In some cases, the search criteria 441 can only provide a partial title (e.g., such as when there is glare or occlusion of the spine). Additionally, the text recognition performed on the book image 431 can be incorrect on occasion. With a sufficient number of correctly recognized words, the search component 440 can identify the book title 445 for a given book, even in instances when words or characters are missing or are incorrectly recognized.

In some variations, the book search component 440 can perform an image comparison process in order to utilize an image signature from a book spine or cover. Specifically, the book search component 440 can compare the signature of a book cover image to signatures of other book cover images in order to determine the book title 445. The performance of the search by book cover image can validate the text-based search, or provide an alternative search to when the text-based search is not possible.

Methodology

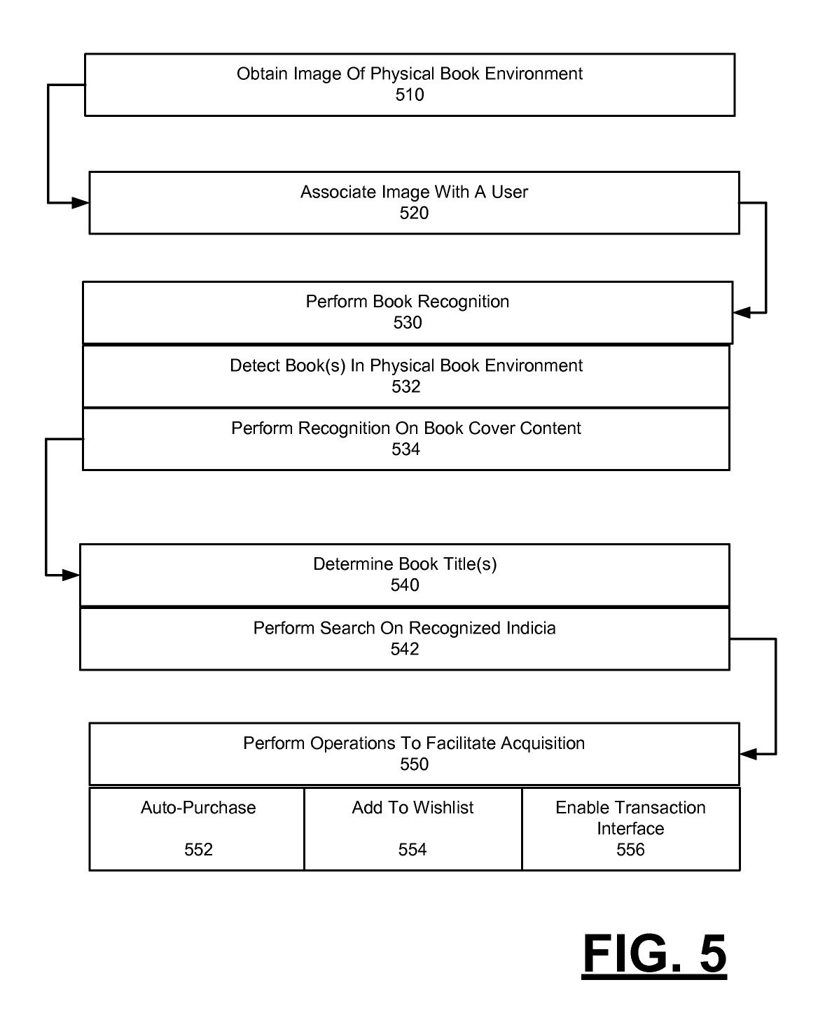

FIG. 5 illustrates an example method for using book recognition to facilitate acquisition of e-books by a user, according to an embodiment. An example of FIG. 5 can be implemented using components such as described with FIG. 1, FIG. 2, FIG. 3 or FIG. 4. Accordingly, reference may be made to elements of other figures for purpose of illustrating suitable elements or components for performing a step or sub-step being described.

With reference to FIG. 5, an image is obtained of a physical book environment (510). The physical book environment can correspond to a bookcase, bookshelf, tabletop or other surface in which multiple books or stacked against or with each other. In one implementation, network service 120 obtains the image of the physical book environment from an e-reading device 200 where the image was captured.

The image of the physical book environment can be associated with the user (520). For example, the e-reading device 200 can establish a socket or other connection with the network service 120 that specifies an account identifier. The image of the physical book environment can be communicated during that session, so that the network service 120 can associate the account identifier with the image.

Book recognition can then be performed on the image by the book recognition component 150 (530). The book recognition process can include detecting the presence of books in the physical book environment (532). For example, the book recognition component 150 can scan an image of the bookshelf to detect one or multiple book spines or jackets depicted in the image. Additionally, the book recognition includes performing recognition of the content appearing on the jackets or covers of individually detected books (534). As described with an example of FIG. 4, text-based and/or image-based recognition can be performed on the content of a book jacket or cover.

From the recognized content, a book title can be determined for individual books depicted in the image (540). As described with an example of FIG. 4, a result of the recognition process can be used to search book library 450 for titles that include the recognized text and/or image (542). In this way, partially recognized text content can yield a full book title.

Once the book titles of the detected books are determined, one or more operations can be performed to facilitate acquisition of the e-book versions corresponding to the identified titles (550). In one example, the e-book versions of the identified titles are automatically purchased (552). For example, the transaction manager 160 can link or otherwise associate the e-book versions of the identified titles to the user account 125, and then debit the user account of corresponding funds for the acquisition. In a variation, the process of acquiring the e-book versions of the identified title is partially automated, such as by way of prompting the user to confirm the acquisition before implementing the transfer. As another example, the transaction manager 160 can add the e-book versions of the identified titles to the user wish list (554). The wish list can represent a list or queue of items which the user wishes to acquire over time. The wish list can also reflect a sequence or priority for acquisition. The addition of the e-book versions to the wish list can include prompting the user to specify priority for the e-book versions being added.

In still another variation, the transaction manager 160 can generate a transaction interface that auto populates information for completing a transaction involving the e-book versions of the identified titles (556). For example, the form can include content corresponding to the e-book versions of the identified titles, as well as an amount for the e-book versions. The user can scan the form in order to select or unselect specific entries. Still further, the form can be generated to enable the user to gift one or more e-books versions of the identified titles.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for enabling acquisition of an e-book, the method being implemented by one or more processors and comprising:
obtaining an image of a physical book environment;
associating the image with a user;
processing the image to detect one or more books in the physical book environment;
determining a title of at least a first book of the one or more books; and
performing one or more operations to facilitate acquisition of an e-book version of the determined title for the user.

2. The method of claim 1, wherein performing one or more operations to facilitate acquisition of the e-book version includes adding the e-book title to a user's wish list or queue.

3. The method of claim 1, wherein performing one or more operations to facilitate acquisition of the e-book version includes automatically implementing a transaction for the e-book version using an account of the user.

4. The method of claim 1, wherein performing one or more operations to facilitate acquisition of the e-book version includes automatically downloading the e-book version onto a device associated with the user.

5. The method of claim 1, wherein:
processing the image includes detecting multiple books on a book shelf, and
wherein determining the title includes determining a title for each book of the multiple books.

6. The method of claim 5, wherein performing the one or more operations includes performing the one or more operations to facilitate acquisition of each determined title for each e-book of the multiple books.

7. The method of claim 6, wherein performing the one or more operations to facilitate acquisition of each determined title for each e-book of the multiple books includes generating an offer that reduces an overall cost for collectively purchasing an e-book version of each of the multiple books as compared to purchasing the e-book version of each of the multiple books individually.

8. The method of claim 1, further comprising communicating the image of the physical book environment and the associated user to a network service, and wherein each of processing the image and determining the title are performed on the network service.

9. The method of claim 1, wherein processing the image to detect one or more books in the physical book environment includes detecting a book shape from the image.

10. The method of claim 1, wherein processing the image to detect one or more books in the physical book environment includes processing the image for a book shape that is vertical, horizontal, or tilted at any one of multiple angles.

11. The method of claim 1, wherein determining the title of at least the first book includes detecting characters that appear on a cover of the first book.

12. The method of claim 11, wherein the cover of the first book is skewed or vertically aligned when provided in the image.

13. The method of claim 1, wherein determining the title of at least the first book includes:
determining a set of characters that appear on a cover of the first book, the set of characters comprising a portion of the title, and
referencing at least the set of characters to a library of titles to identify a title of the first book based on the set of characters.

14. The method of claim 1, wherein determining the title of at least the first book includes:
determining an image that appears on a cover of the first book, and
referencing at least the image to a library of images to identify a title of the first book.

15. The method of claim 1, wherein determining the title of at least the first book includes detecting a book shelf as the physical book environment, and then detecting a book cover on the book shelf.

16. A computing system comprising:
a memory that stores a set of instructions;
one or more processors that use instructions from the memory to:
associate an image with a user, the image being captured on a device associated with the user, and the image depicting a physical book environment with multiple books;
process the image to detect each of the multiple books in the physical book environment;
determine a title of each book in the multiple books; and
perform one or more operations to facilitate acquisition by the user of an e-book version of the determined title for each book in the multiple books.

17. The computing device of claim 16, wherein the one or more processors perform the one or more operations to facilitate acquisition by the user of an e-book version of the determined title for each book in the multiple books by adding the e-book version of the determined title of each of the multiple books to a user's wish list or queue.

18. The computing device of claim 16, wherein the one or more processors perform the one or more operations to facilitate acquisition of the e-book version of each book in the in the multiple books by automatically implementing a transaction for each e-book version using an account of the user.

19. The computing device of claim 16, wherein the one or more processors perform the one or more operations to facilitate acquisition of the e-book version of each book in the in the multiple books automatically downloading each e-book version onto a device associated with the user.

20. A non-transitory computer-readable medium that stores instructions for organizing e-books on a computing device, the computer-readable medium including instructions that, when executed by one or more processors, cause the one or more processors to perform operations comprising:
capturing an image of a scene that includes a physical book environment;
associating the image with a user;
processing the image to detect one or more books in the physical book environment;
determining a title of at least a first book of the one or more books; and
performing one or more operations to facilitate acquisition of an e-book version of the determined title for the user.
